(19) United States
(12) Patent Application Publication
(10) Pub. No.: US 2021/0333116 A1
(43) Pub. Date: Oct. 28, 2021

(54) INFORMATION PROCESSING DEVICE, PROGRAM, AND INFORMATION PROCESSING METHOD

(71) Applicant: Toyota Jidosha Kabushiki Kaisha, Toyota-shi Aichi-ken (JP)

(72) Inventors: Tsuyoshi Andou, Toyota-shi (JP); Akitoshi Jikumaru, Nisshin-shi (JP); Ryosuke Kobayashi, Nagakute-shi (JP); Tomokazu Maya, Nagoya-shi (JP); Masatoshi Hayashi, Nisshin-shi (JP)

(73) Assignee: Toyota Jidosha Kabushiki Kaisha, Toyota-shi Aichi-ken (JP)

(21) Appl. No.: 17/196,517

(22) Filed: Mar. 9, 2021

(30) Foreign Application Priority Data
Apr. 24, 2020 (JP) 2020-077695

(51) Int. Cl. G01C 21/34; B60W 40/09; G06K 9/00; B62D 15/02; G06N 20/00; G06K 9/62

(52) U.S. Cl. CPC G01C 21/3438; B60W 40/09; G01C 21/3484; G06K 9/6256; B62D 15/021; G06K 9/00302; G06N 20/00; G06K 9/00845

(57) ABSTRACT

An information processing device includes a communication unit and a controller. The controller specifies a user who applied for ride-sharing based on application information for applying for the ride-sharing received by the communication unit. The controller decides a driver to be recommended to the user from a plurality of drivers, based on preference information showing a preference degree of the user for a driving habit and driving information showing a driving habit of each of the drivers.

### CROSS-REFERENCE TO RELATED APPLICATION

This application claims priority to Japanese Patent Application No. 2020-077695 filed on Apr. 24, 2020, incorporated herein by reference in its entirety.

### BACKGROUND

### 1. Technical Field

The present disclosure relates to an information processing device, a program, and an information processing method.

### 2. Description of Related Art

Conventionally, a technique for matching a driver of a vehicle with a user who wants to get on the vehicle is known (for example, Japanese Unexamined Patent Application Publication No. 2004-54444 (JP 2004-54444 A)). JP 2004-54444 A discloses an operation service information mediating system. The system described in JP 2004-54444 A includes a user terminal group owned by each of a passenger group and a taxi group and an information mediating device of an information mediator who mediates operation service information between the passenger group and the taxi group.

### SUMMARY

In the conventional technique, improvement of user convenience is desired.

The present disclosure improves user convenience.

A first aspect of the present disclosure relates to an information processing device. The information processing device includes a communication unit, and a controller configured to specify a user who applied for ride-sharing based on application information for applying for the ride-sharing received by the communication unit, and decide a driver to be recommended to the user from a plurality of drivers, based on preference information showing a preference degree of the user for a driving habit and driving information showing a driving habit of each of the drivers.

A second aspect of the present disclosure relates to a program that causes a computer to execute an operation. The operation includes receiving application information for applying for ride-sharing, specifying a user who applied for the ride-sharing based on the application information, and deciding a driver to be recommended to the user from a plurality of drivers, based on preference information showing a preference degree of the user for a driving habit and driving information showing a driving habit of each of the drivers.

A third aspect of the present disclosure relates to an information processing method. The information processing method includes, by an information processing device, receiving application information for applying for ride-sharing, by the information processing device, specifying a user who applied for the ride-sharing based on the application information, and by the information processing device, deciding a driver to be recommended to the user from a plurality of drivers, based on preference information showing a preference degree of the user for a driving habit and driving information showing a driving habit of each of the drivers.

According to the aspect of the present disclosure, the convenience of the user can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of an information processing system according to a first embodiment of the present disclosure;

FIG. 2 is a block diagram showing a detailed configuration of the information processing system shown in FIG. 1;

FIG. 3 is a diagram showing an example of preference information according to the first embodiment of the present disclosure;

FIG. 4 is a diagram showing an example of driving information according to the first embodiment of the present disclosure;

FIG. 5 is a flowchart showing an operation of the information processing system according to the first embodiment of the present disclosure;

FIG. 6 is a diagram illustrating a concept of a model according to a second embodiment of the present disclosure; and

FIG. 7 is a flowchart showing an operation of the information processing system according to the second embodiment of the present disclosure.

### DETAILED DESCRIPTION OF EMBODIMENTS

Hereinafter, embodiments of the present disclosure will be described with reference to the drawings. In components shown in the drawings below, the same components are designated by the same reference signs.

### First Embodiment

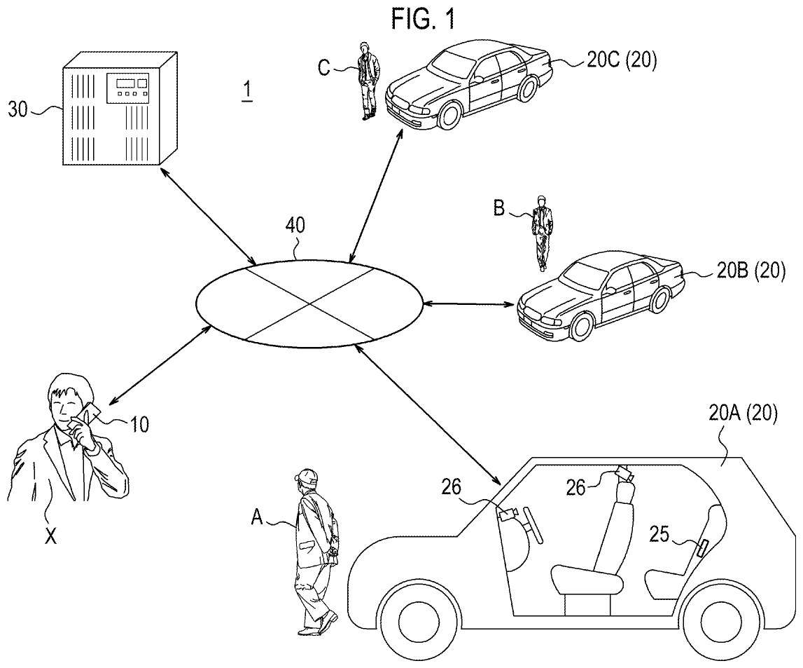

As shown in FIG. 1, an information processing system 1 according to a first embodiment of the present disclosure includes a terminal device 10, a vehicle 20A, a vehicle 20B, a vehicle 20C, and an information processing device 30.

Hereinafter, in a case where the vehicle 20A, the vehicle 20B, the vehicle 20C are not particularly distinguished, the vehicles are collectively referred to as the “vehicle 20”. FIG. 1 shows the information processing system 1 including three vehicles 20. The number of vehicles 20 included in the information processing system 1 is not limited to three. The information processing system 1 may include at least one vehicle 20.

The terminal device 10, the vehicle 20, and the information processing device 30 can communicate with each other via a network 40. The network 40 may be any network including a mobile communication network, the Internet, or the like.

The information processing system 1 may provide a ride-sharing service. The ride-sharing service is a service that matches a user who wants to share a ride, with a pre-registered driver. Examples of the user include a user X. Examples of the pre-registered driver include a driver A, a driver B, a driver C. When the matching is established, the user may get on the vehicle 20 driven by the matched driver.

The terminal device 10 may be used by the user. For example, the terminal device 10 may be used by the user X. A dedicated application that provides the ride-sharing service may be installed in the terminal device 10. The user may apply for the use of the ride-sharing service via the terminal device 10.

The terminal device 10 may be any device as long as the dedicated application or the like that provides the ride-sharing service can be used. For example, the terminal device 10 is a mobile phone, a smartphone, a tablet, or a personal computer (PC).

The vehicle 20 may be driven by the driver. The driver who drives the vehicle 20 may be the driver registered in advance in the ride-sharing service. For example, the drivers of the vehicles 20A, 20B, 20C may be the drivers A, B, C, respectively. Note that, different drivers may drive the same vehicle 20, for example, at different time zones. For example, the driver A and the driver B may drive the vehicle 20A at different time zones.

The vehicle 20 may be any type of automobile. For example, the vehicle 20 is a gasoline vehicle, a diesel vehicle, a hybrid vehicle (HV), a plug-in hybrid vehicle (PHV), an electric vehicle (EV), or a fuel cell vehicle (FCV). The vehicle 20 may be driven by the driver. Driving of the vehicle 20 may be automated at any level. For example, a level of automation is any of levels from one to five in society of automotive engineers (SAE) leveling. The vehicle 20 may be a vehicle dedicated to mobility as a service (MaaS).

The vehicle 20 may be shared by the driver and the user matched by the ride-sharing service. Here, a driving habit of the driver may differ depending on the driver due to driving skill, personality, or the like of the driver. The driving habit is a habit that appears in a traveling state or the like of the vehicle 20 when the driver operates operating equipment of the vehicle 20 to drive the vehicle 20. For example, the driving habit is a habit of meandering driving, a habit of safe driving, and a habit of dangerous driving. In addition, a user's preference for the driving habit of the driver may differ depending on the user. For example, in a case where the user is prone to car sickness and the driver tends to drive meanderingly, the user may feel uncomfortable with the driving of the driver. For example, in a case where the user prefers safe driving and the driver tends to drive safely, the user may feel favorable to the driving of the driver.

The information processing device 30 can provide the ride-sharing service. The information processing device 30 matches the user who applied for the use of the ride-sharing service with the pre-registered driver. When matching the user with the driver, the information processing device 30 can recommend a driver having a driving habit that suits the user's preference from a plurality of drivers by processing described later. With such a configuration, the possibility that the user feels uncomfortable with the driving of the driver when the user is sharing the vehicle 20 may decrease. In addition, the possibility that the user feels favorable to the driving of the driver when the user is sharing the vehicle 20 may increase.

The information processing device 30 may be a dedicated computer configured to function as a server, a general-purpose personal computer, a cloud computing system, or the like.

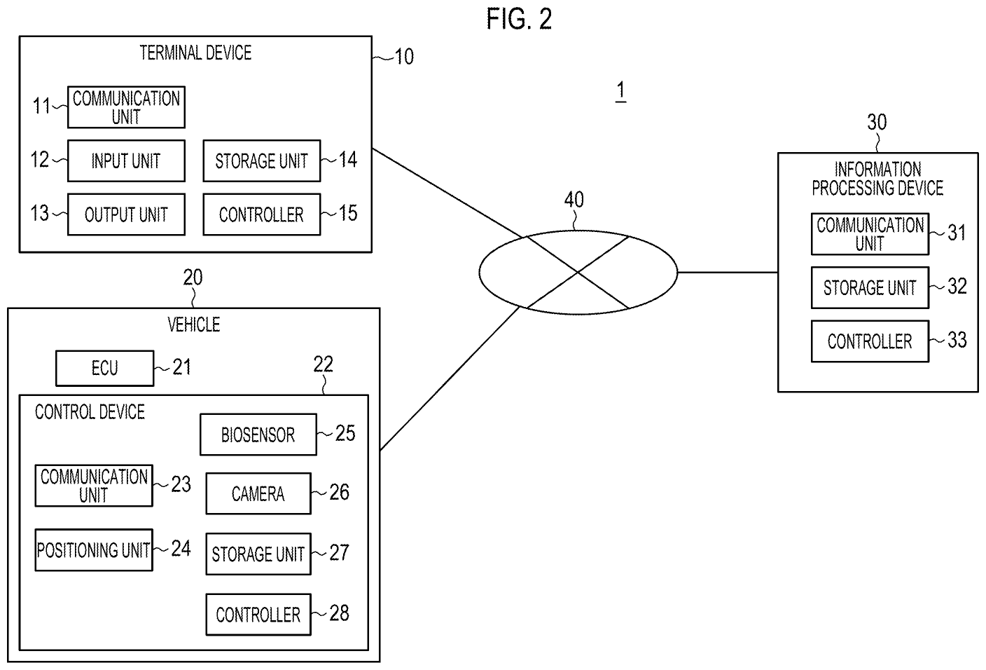

As shown in FIG. 2, the terminal device 10 includes a communication unit 11, an input unit 12, an output unit 13, a storage unit 14, and a controller 15.

The communication unit 11 may be configured to include at least one communication module that can be connected to the network 40. For example, the communication module is a module compatible with a mobile communication standard, such as long term evolution (LTE), 4th generation (4G), or 5th generation (5G).

The input unit 12 can receive input from the user. The input unit 12 may be configured to include at least one input interface that can receive input from the user. The input interface may be a physical key, a capacitive key, a pointing device, a touch screen provided integrally with a display, a microphone, or the like. The input unit 12 may be provided in the terminal device 10 or may be connected to the terminal device 10 as external input equipment. In a case where the input unit 12 is connected to the terminal device 10 as the external input equipment, a connection method between the input unit 12 and the terminal device 10 may be any connection method. For example, the connection method is universal serial bus (USB), high-definition multimedia interface (HDMI, registered trademark), Bluetooth (registered trademark), or the like.

The output unit 13 can output data. The output unit 13 may be configured to include at least one output interface that can output data. The output interface may be a display, a speaker, or the like. The display may be a liquid crystal display (LCD), an organic electro luminescence (EL) display, or the like. The output unit 13 may be provided in the terminal device 10 or may be connected to the terminal device 10 as external output equipment. In a case where the output unit 13 is connected to the terminal device 10 as the external output equipment, the connection method between the output unit 13 and the terminal device 10 may be any connection method. For example, the connection method is USB, HDMI (registered trademark), Bluetooth (registered trademark), or the like.

The storage unit 14 may be configured to include at least one semiconductor memory, at least one magnetic memory, at least one optical memory, or a combination of at least two of these. The semiconductor memory is, for example, a random access memory (RAM) or a read only memory (ROM). The RAM is, for example, a static random access memory (SRAM) or a dynamic random access memory (DRAM). The ROM is, for example, an electrically erasable programmable read only memory (EEPROM). The storage unit 14 may function as a main storage device, an auxiliary storage device, or a cache memory. The storage unit 14 stores data used for an operation of the terminal device 10 and data obtained by the operation of the terminal device 10.

The controller 15 may be configured to include at least one processor, at least one dedicated circuit, or a combination thereof. The processor is a general-purpose processor, such as a central processing unit (CPU) or a graphics processing unit (GPU), or a dedicated processor specialized for specific processing. The dedicated circuit is, for example, a field-programmable gate array (FPGA) or an application specific integrated circuit (ASIC). The controller 15 may execute processing related to the operation of the terminal device 10 while controlling each unit of the terminal device 10.

A function of the terminal device 10 may be implemented by executing a terminal control program according to the present embodiment by the processor corresponding to the controller 15. That is, the function of the terminal device 10 may be implemented by software. The terminal control program may cause a computer to function as the terminal device 10 by causing the computer to execute the operation of the terminal device 10. That is, the computer may function as the terminal device 10 by executing the operation of the terminal device 10 according to the terminal control program.

In the present disclosure, the “program” can be recorded on a computer-readable non-transitory recording medium. The computer-readable non-transitory recording medium is, for example, a magnetic recording device, an optical disc, an optical magnetic recording medium, or a ROM. The distribution of the program may be carried out, for example, by selling, transferring, or renting a portable recording medium, such as a digital versatile disc (DVD) or a compact disc read only memory (CD-ROM) on which the program is recorded. The program may be stored in a storage of a server. The program stored in the storage of the server may be distributed by being transferred to other computers. The program may be provided as a program product.

In the present disclosure, the “computer”, for example, may temporarily store the program recorded on the portable recording medium or the program transferred from the server in the main storage device. Further, the computer may read the program stored in the main storage device by the processor and execute processing according to the read program by the processor. The computer may read the program directly from the portable recording medium and execute the processing according to the program. The computer may sequentially execute the processing according to the received program each time the program is transferred from the server to the computer. The computer may execute the processing by an application service provider (so-called ASP) type service that implements the function solely by an execution instruction and result acquisition without transferring the program from the server to the computer. The program may include information provided for processing by an electronic computer, which is equivalent to the program. For example, data that is not a direct command to the computer and has a property of defining the processing of the computer corresponds to the “equivalent to the program”.

Some or all the functions of the terminal device 10 may be implemented by the dedicated circuit corresponding to the controller 15. That is, some or all the functions of the terminal device 10 may be implemented by hardware.

The controller 15 may receive a user input to apply for ride-sharing by the input unit 12. The user input is input from the input unit 12 by a user who wants to use the ride-sharing service. The user input may include an input of information for identifying the user, an input of a boarding position desired by the user, an input of an alighting position desired by the user, and the like. The information for identifying the user may be at least any of user's membership number in the ride-sharing service, e-mail address and telephone number of the terminal device 10 used by the user. The controller 15 generates application information when the controller 15 received the input. The application information may include the information for identifying the user, information on the boarding position desired by the user, information on the alighting position desired by the user, and the like. The controller 15 transmits the generated application information to the information processing device 30 via the network 40, by the communication unit 11.

After the controller 15 transmits the application information, the controller 15 may receive recommendation information from the information processing device 30 via the network 40, by the communication unit 11. As described later, the recommendation information may include information on a driver to be recommended to the user. The controller 15 causes the output unit 13 to output the received recommendation information. The recommendation information is output from the output unit 13, so that the user may grasp a content of the recommendation information. In a case where the user decides to share the vehicle 20 driven by the recommended driver, the user inputs an input showing a ride-sharing decision from the input unit 12. When the controller 15 receives the input showing the ride-sharing decision by the input unit 12, the controller 15 may transmit a notification showing the ride-sharing decision to the information processing device 30 via the network 40, by the communication unit 11. After the controller 15 transmits the notification showing the ride-sharing decision, the controller 15 may receive reservation information from the information processing device 30 via the network 40, by the communication unit 11. As described later, the reservation information may include a notification showing reservation completion, or the like. The controller 15 causes the output unit 13 to output the reservation information. After that, the user may get on the vehicle 20 driven by a driver who decides to share.

The controller 15 may receive an input showing an evaluation of a driving of the driver by the input unit 12. The input is input from the input unit 12 by the user during the ride-sharing of the vehicle 20 or after the ride-sharing of the vehicle 20. When the controller 15 receives the input by the input unit 12, the controller 15 may transmit input information showing the evaluation of the driving of the driver to the information processing device 30 via the network 40, by the communication unit 11.

As shown in FIG. 2, the vehicle 20 includes an electronic control unit (ECU) 21 and a control device 22. The ECU 21 and the control device 22 are communicably connected to each other. The control device 22 includes a communication unit 23, a positioning unit 24, a biosensor 25, a camera 26, a storage unit 27, and a controller 28. The storage unit 27 and the controller 28 may be a part of the ECU 21.

The ECU 21 can control various equipment mounted in the vehicle 20. The ECU 21 outputs driving operation information described later to the controller 28.

The communication unit 23 may be configured to include at least one communication module that can be connected to the network 40, as the configuration of the communication unit 11.

The positioning unit 24 can acquire position information of the vehicle 20. The positioning unit 24 outputs the position information of the vehicle 20 to the controller 28. The positioning unit 24 may be configured to include a global positioning system (GPS) receiving module.

The biosensor 25 can detect biometric information of the user who is sharing the vehicle 20. The biosensor 25 outputs detection result to the controller 28. The biometric information may be at least any of a pulse rate, blood pressure, and a respiratory rate. The biosensor 25 may be at least any of a pulse sensor that can detect a pulse rate, a blood pressure sensor that can detect blood pressure, and a respiratory sensor that can detect a respiratory rate. The biosensor 25 may be disposed at any position where the biometric information of the user who is sharing the vehicle 20 can be detected. For example, in a case where the biosensor is the pulse sensor, the biosensor 25 may be disposed at at least any of a back seat and a passenger seat of the vehicle 20 as shown in FIG. 1. The user who is sharing the vehicle 20 may sit in at least any of the back seat and the passenger seat of the vehicle 20.

The camera 26 can image a face image of the user who is sharing the vehicle 20. The camera 26 outputs the face image of the user to the controller 28. The camera 26 may be disposed at any position where the face image of the user who is sharing the vehicle 20 can be imaged. The camera 26 may be disposed at a dashboard of the vehicle 20 as shown in FIG. 1 such that the face image of the user sitting in the passenger seat of the vehicle 20 can be imaged. The camera 26 may be disposed at a pillar of the vehicle 20 as shown in FIG. 1 such that the face image of the user sitting in the back seat of the vehicle 20 can be imaged.

The storage unit 27 may be configured to include at least one semiconductor memory, at least one magnetic memory, at least one optical memory, or a combination of at least two of these, as the configuration of the storage unit 14. The storage unit 27 stores data used for an operation of the vehicle 20 and data obtained by the operation of the vehicle 20.

The controller 28 may be configured to include at least one processor, at least one dedicated circuit, or a combination thereof, as the configuration of the controller 15. The controller 28 may execute processing related to the operation of the vehicle 20 while controlling each unit of the vehicle 20.

A function of the control device 22 is implemented by executing a vehicle control program according to the present embodiment by the processor included in the controller 28. That is, the function of the control device 22 is implemented by software. The vehicle control program is a program for causing the computer to execute processing of a step included in an operation of the control device 22, so that the computer can implement a function corresponding to the processing of the step. That is, the vehicle control program is a program for causing the computer to function as the control device 22.

Some or all the functions of the control device 22 may be implemented by the dedicated circuit included in the controller 28. That is, some or all the functions of the control device 22 may be implemented by hardware.

The controller 28 may acquire the position information of the vehicle 20 by the positioning unit 24 at preset time intervals. The time interval may be appropriately set based on an average speed of the vehicle 20 or the like. The controller 28 may transmit the acquired position information of the vehicle 20 to the information processing device 30 via the network 40, by the communication unit 23. The controller 28 may transmit the acquired position information of the vehicle 20 to the information processing device 30 together with information for identifying the driver of the vehicle 20. The information for identifying the driver of the vehicle 20 may be a registration number of the driver in the ride-sharing service or the like.

The controller 28 may acquire the driving operation information from the ECU 21. The controller 28 may acquire the driving operation information while the driver is driving the vehicle 20. The driving operation information may be information that enables to distinguish the driving habit of the driver by analyzing the driving operation information.

The driving operation information may include information showing an operation of the driver on operating equipment of the vehicle 20. The operating equipment of the vehicle 20 is, for example, an accelerator, a brake, and a steering. In this case, the driving operation information may be information showing a history of at least any of an operation of the driver on the accelerator, an operation of the driver on the brake, and an operation of the driver on the steering.

The driving operation information may include information showing a state of the vehicle 20 or the like when the vehicle 20 travels or the like as the driver operates the operating equipment of the vehicle 20. In this case, the driving operation information may include at least any of speed information of the vehicle 20, acceleration information of the vehicle 20, and wheel steer angle information of the vehicle 20. The speed information of the vehicle 20 may be information showing a history of the speed of the vehicle 20. The acceleration information of the vehicle 20 may be information showing a history of the acceleration of the vehicle 20. The acceleration of the vehicle 20 may include acceleration in a traveling direction of the vehicle 20 and acceleration in a direction opposite to the traveling direction of the vehicle 20. The wheel steer angle information of the vehicle 20 may be information showing a history of the wheel steer angle.

Hereinafter, the driving operation information will be described as including the speed information of the vehicle 20, the acceleration information of the vehicle 20, and the wheel steer angle information of the vehicle 20.

The controller 28 may transmit the acquired driving operation information to the information processing device 30 via the network 40, by the communication unit 23. The controller 28 may transmit the driving operation information to the information processing device 30 together with the information for identifying the driver of the vehicle 20. The controller 28 may transmit the driving operation information to the information processing device 30 at preset time intervals. The time interval may be appropriately set based on a time for the driver to drive the vehicle 20 or the like. In addition, the controller 28 may receive a notification requesting transmission of the driving operation information from the information processing device 30 via the network 40, by the communication unit 23. When the controller 28 receives the notification requesting transmission of the driving operation information, the controller 28 may transmit the driving operation information to the information processing device 30.

The controller 28 may acquire the biometric information of the user from the biosensor 25. The controller 28 may transmit the biometric information of the user to the information processing device 30 via the network 40, by the communication unit 23. The controller 28 may receive a notification showing a transmission request of the biometric information of the user from the information processing device 30 via the network 40, by the communication unit 23. When the controller 28 receives the notification showing the transmission request, the controller 28 may transmit the biometric information of the user.

The controller 28 may acquire the face image of the user from the camera 26. The controller 28 may transmit the face image of the user to the information processing device 30 via the network 40, by the communication unit 23. The controller 28 may receive a notification showing a transmission request of the face image of the user from the information processing device 30 via the network 40, by the communication unit 23. When the controller 28 receives the notification showing the transmission request, the controller 28 may transmit the face image of the user.

As shown in FIG. 2, the information processing device 30 includes a communication unit 31, a storage unit 32, and a controller 33.

The communication unit 31 may be configured to include at least one communication module that can be connected to the network 40. For example, the communication module is a module compatible with a standard, such as a wired local area network (LAN) or a wireless LAN. The communication unit 31 may be connected to the network 40 via the wired LAN or the wireless LAN, by the communication module.

The storage unit 32 may be configured to include at least one semiconductor memory, at least one magnetic memory, at least one optical memory, or a combination of at least two of these, as the configuration of the storage unit 14. The storage unit 32 stores data used for an operation of the information processing device 30 and data obtained by the operation of the information processing device 30.

The controller 33 may be configured to include at least one processor, at least one dedicated circuit, or a combination thereof, as the configuration of the controller 15. The controller 33 may execute processing related to the operation of the information processing device 30 while controlling each unit of the information processing device 30.

A function of the information processing device 30 may be implemented by executing an information processing program according to the present embodiment by the processor corresponding to the information processing device 30. That is, the function of the information processing device 30 may be implemented by software. The information processing program may cause a computer to function as the information processing device 30 by causing the computer to execute the operation of the information processing device 30. That is, the computer may function as the information processing device 30 by executing the operation of the information processing device 30 according to the information processing program.

Some or all the functions of the information processing device 30 may be implemented by the dedicated circuit corresponding to the controller 33. That is, some or all the functions of the information processing device 30 may be implemented by hardware.

The controller 33 may receive the application information from the terminal device 10 via the network 40, by the communication unit 31. As described above, the application information may include the information for identifying the user, the information on the boarding position desired by the user, the information on the alighting position desired by the user, and the like. The controller 33 specifies a user who applied for the ride-sharing based on the information for identifying the user. In addition, the controller 33 may select a driver who can share a ride with the specified user from a plurality of the pre-registered drivers. For example, the controller 33 acquires the position information of at least one vehicle 20 from at least one of a plurality of the vehicles 20 via the network 40, by the communication unit 31. The controller 33 extracts the vehicle 20 within a preset range from the boarding position desired by the user, based on the acquired position information of the vehicle 20. The range for extracting the vehicle 20 may be appropriately set depending on an area. The controller 33 selects a driver of the extracted vehicle 20 as the driver who can share a ride with the specified user.

Decision Processing of Recommended Driver

For example, in a case where a plurality of the drivers is selected, the controller 33 decides the driver to be recommended to the user who applied for the ride-sharing from the drivers, based on preference information and driving information. The preference information is information showing a preference degree of the user to the driving habit. In the present embodiment, the preference degree is an index showing a degree of a user's preference. Note that, the preference degree may be an index showing a degree of a user's satisfaction or a degree of a user's relaxation. In the present embodiment, a driving habit corresponding to a high preference degree suits the user's preference more than a driving habit corresponding to a low preference degree. Further, the driving information is information showing a driving habit of each of the drivers. Based on such preference information and driving information, the controller 33 can recommend the driver having the driving habit that suits the user's preference to the user who applied for the ride-sharing.

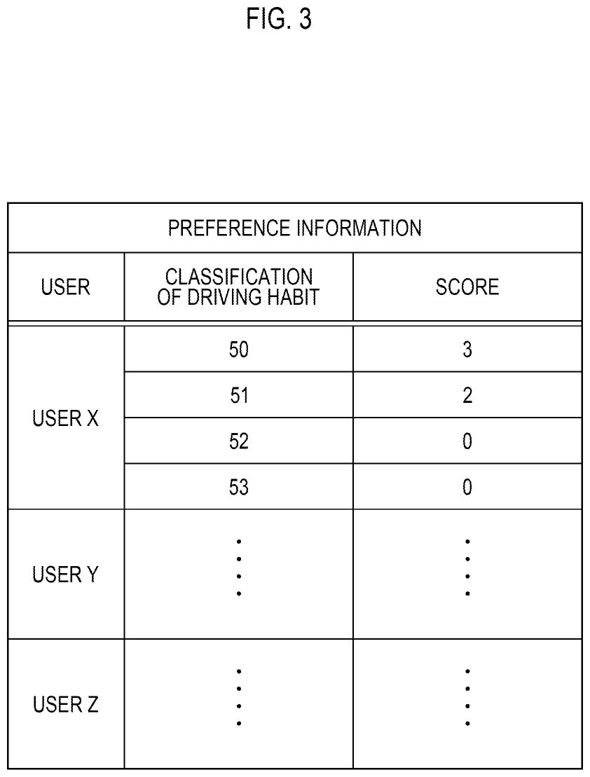

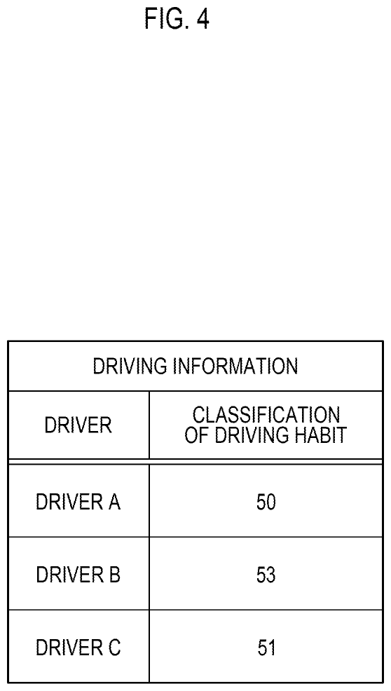

In the first embodiment, the controller 33 decides the driver to be recommended to the user who applied for the ride-sharing from the drivers by collating the preference information as shown in FIG. 3 with the driving information as shown in FIG. 4.

As shown in FIGS. 3 and 4, the driving habits may be distinguished by preset classifications. Classifications 50, 51, 52, 53 are examples of the classification of the driving habit. The classification of the driving habit may be appropriately set based on a driving habit that may affect a general user's preference. The classification of the driving habit may be defined by the speed of the vehicle 20, the acceleration of the vehicle 20, a movement of the wheel steer angle of the vehicle 20, and the like.

The classification 50 is a classification in which the average speed of the vehicle 20 is lower than the legal speed. The classification 50 is a classification in which an average acceleration of the vehicle 20 is lower than a preset set value. The set value may be appropriately set based on a load applied to the human body by the acceleration. The classification 50 is a classification in which the movement of the wheel steer angle of the vehicle 20 is slower than a general movement of the wheel steer angle. The classification 50 may show a habit of so-called safe driving.

The classification 51 is a classification in which the average speed of the vehicle 20 is lower than a general average speed of the vehicle. The classification 51 is a classification in which the average acceleration of the vehicle 20 is lower than the preset set value. The set value may be the same as the above-described set value in the classification 50. In the classification 51, the movement of the wheel steer angle of the vehicle 20 tends to be about the same as the general movement of the wheel steer angle. The classification 51 may show a habit of so-called slow driving.

The classification 52 is a classification in which the average speed and the average acceleration of the vehicle 20 are about the same as the general average speed and a general average acceleration of the vehicle. The classification 52 is a classification in which the wheel steer angle of the vehicle 20 changes more frequently than the general wheel steer angle of the vehicle. The classification 52 is a classification in which an amount of change in the wheel steer angle of the vehicle 20 is larger than a general amount of change in the wheel steer angle of the vehicle. The classification 52 may show a habit of so-called meandering driving.

The classification 53 is a classification in which the average speed of the vehicle 20 is faster than the legal speed. The classification 53 is a classification in which the average acceleration of the vehicle 20 is higher than the general average acceleration of the vehicle. The classification 53 is a classification in which the wheel steer angle of the vehicle 20 changes more frequently than the general wheel steer angle of the vehicle. The classification 53 may show a habit of so-called dangerous driving.

As shown in FIG. 3, the preference degree in the preference information may be a score. Note that, the preference degree is not limited to the score. For example, the preference degree may be a flag or the like showing the degree of the user's preference. In a case where the preference degree is a score, a driving habit corresponding to a high score suits the user's preference more than a driving habit corresponding to a low score. In a case where the driving habits are distinguished by the classifications as shown in FIG. 3, a classification of the driving habit corresponding to a high score suits the user's preference more than a classification of the driving habit corresponding to a low score.

In the preference information as shown in FIG. 3, the score of the user X for the classification 50 is “3”. The score of the user X for classification 51 is “2”. The score of the user X for each of the classifications 52, 53 is “0”.

In the driving information as shown in FIG. 4, a classification of a driving habit of the driver A is the classification 50. A classification of a driving habit of the driver B is the classification 53. A classification of a driving habit of the driver C is the classification 51.

When collating the preference information with the driving information, the controller 33 may specify a classification of a driving habit corresponding to the highest score for the user who applied for the ride-sharing, with reference to the preference information as shown in FIG. 3. The controller 33 may determine whether there is a driver who belongs to the same classification of the driving habit as the specified classification of the driving habit corresponding to the highest score, in the drivers selected as described above, with reference to the driving information as shown in FIG. 4. In a case where the controller 33 determines that there is the driver who belongs to the same classification of the driving habit as the specified classification of the driving habit corresponding to the highest score, the controller 33 may decide to recommend the driver to the user. In a case where the controller 33 determines that there is no driver who belongs to the same classification of the driving habit, the controller 33 may decide to recommend, from the drivers, a driver who belongs to a classification of a driving habit similar to the specified classification of the driving habit corresponding to the highest score to the user. The similar classification of the driving habit may be appropriately decided depending on a factor, such as the speed of the vehicle 20 that defines the classification of the driving habit.

For example, it is assumed that the controller 33 specifies the user X as the user who applied for the ride-sharing. Further, it is assumed that the controller 33 selects all the drivers A to C as drivers who can share a ride with the user X. In this case, that the controller 33 specifies that the classification of the driving habit corresponding to the highest score for the user X is the classification 50, with reference to the preference information as shown in FIG. 3. The controller 33 determines that there is the driver A who belongs to the same classification of the driving habit as the classification 50, in the drivers A to C, with reference to the driving information as shown in FIG. 4. The controller 33 decides to recommend the driver A to the user X.

For example, it is assumed that the controller 33 specifies the user X as the user who applied for the ride-sharing. Further, it is assumed that the controller 33 selects the driver B and the driver C as drivers who can share a ride with the user X. In this case, the controller 33 determines that there is no driver who belongs to the classification 50, with reference to the driving information as shown in FIG. 4. Here, it is assumed that the classification 50 and the classification 51 are the classifications of similar driving habits in that the average acceleration of the vehicle 20 is lower than the preset set value. In this case, the controller 33 decides to recommend the driver C who belongs to the classification 51 to the user X, from the driver B and the driver C.

Transmission Processing of Reservation Information

When the controller 33 decides the recommended driver, the controller 33 generates the recommendation information. The recommendation information may include the information on the driver to be recommended to the user. The information on the recommended driver may include contact numbers of the driver, or the like. The information on the recommended driver may include information showing the driving habit of the driver. The information showing the driving habit of the driver may be information showing the classification of the driving habit of the driver. The controller 33 transmits the generated recommendation information to the terminal device 10 via the network 40, by the communication unit 31. After the controller 33 transmits the recommendation information, the controller 33 may receive the notification showing the ride-sharing decision from the terminal device 10 via the network 40, by the communication unit 31. When the controller 33 receives the notification showing the ride-sharing decision, the controller 33 generates the reservation information. The reservation information includes the notification showing reservation completion, the driver information, information on the vehicle 20 driven by the driver, the information on the boarding position, the information on the alighting position, and the like. The controller 33 transmits the generated reservation information to the terminal device 10 via the network 40, by the communication unit 31. The controller 33 may transmit the generated reservation information to the terminal device of the driver who is decided to share a ride via the network 40, by the communication unit 31.

Generation or Update Processing of Driving Information

The controller 33 may receive the driving operation information acquired in the vehicle 20 while at least one of the drivers is driving, from the vehicle 20 via the network 40, by the communication unit 31. The controller 33 may receive the driving operation information from the vehicle 20 via the network 40 together with the information for identifying the driver. The controller 33 may acquire the driving habit of each of the drivers by analyzing the received driving operation information. In a case where the driving habits are distinguished by the preset classifications as described above, the controller 33 may decide the classification of the driving habit of each of the drivers by analyzing the received driving operation information. The controller 33 may generate the information showing the driving habit of the driver by associating the decided classification of the driving habit with the information for identifying the driver received from the vehicle 20. For example, in a case where the controller 33 decides that the classification of the driving habit of the driver A is the classification 50, the controller 33 generates information showing the driving habit of the driver A by associating information for identifying the driver A received from the vehicle 20A with the classification 50.

The controller 33 may generate or update at least some of the driving information with the generated information showing the driving habit of the driver. In a case where the information for identifying the driver received from the vehicle 20 does not exist in the driving information, the controller 33 may generate at least some of the driving information by including the generated information showing the driving habit of the driver in the driving information. In a case where the information for identifying the driver received from the vehicle 20 already exists in the driving information, the controller 33 may replace the classification of the driving habit associated with the information for identifying the driver that already exists with a newly decided classification of the driving habit, in the driving information. The controller 33 may update at least some of the driving information by replacing the classifications of the driving habits, in the driving information.

The controller 33 may decide the recommended driver by collating updated driving information with the preference information in the above-described decision processing of the recommended driver. Here, the driving habit of the driver may be changed by various factors, such as improvement and regression of the driving skill of the driver and the psychological condition of the driver. That is, the driving habit of the driver may change in a relatively short period of about several days. The driving information may be information showing the latest driving habit of the driver by updating the driving information. Since the driving information is the information showing the latest driving habit of the driver, the controller 33 can recommend the driver having the driving habit that suits the user's preference more accurately.

The controller 33 may generate or update at least some of the driving information by receiving the above-described driving operation information from the vehicle 20 at preset time intervals. As described above, the vehicle 20 may transmit the driving operation information of the vehicle 20 to the information processing device 30 at preset time intervals.

When the controller 33 receives the application information by the communication unit 31 in the above-described decision processing of the recommended driver, the controller 33 may generate or update at least some of the driving information. With such a configuration, the driving information may be updated immediately after the information processing device 30 receives the application information. Since the driving information is updated immediately after the information processing device 30 receives the application information, the controller 33 can recommend the driver having the driving habit that suits the user's preference more accurately. Here, when the controller 33 receives the above-described application information, the controller 33 may transmit the notification requesting transmission of the driving operation information to the vehicles 20 via the network 40, by the communication unit 31. The controller 33 can receive the above-described driving operation information from the vehicle 20, by transmitting the notification requesting transmission of the driving operation information to the vehicle 20.

Generation or Update Processing of Preference Information

Hereinafter, a period during which the driver and the user are sharing the vehicle 20 is also referred to as “ride-sharing period”. The controller 33 may acquire the position information of the vehicle 20 that the user shares, via the network 40 at preset time intervals. The controller 33 may consider a period from when a position of the vehicle 20 matches the boarding position of the reservation information to when the position of the vehicle 20 matches the alighting position of the reservation information as the ride-sharing period.

The controller 33 may generate or update at least some of the preference information with the driving operation information acquired in the vehicle 20 shared by the user and a result of estimating the preference degree of the user for the driving habit of the driver of the vehicle 20 shared by the user, from reaction information. The reaction information is information showing a reaction to the driving of the driver of the vehicle 20 shared by the user that is shown by the user during or after the ride-sharing. Here, the controller 33 may receive the driving operation information acquired in the vehicle 20 shared by the user via the network 40, by the communication unit 31. The controller 33 may decide the classification of the driving habit of the driver of the vehicle 20 shared by the user based on the received driving operation information. The controller 33 may generate or update at least some of the preference information with the decided classification of the driving habit of the driver and the reaction information. Hereinafter, examples of the reaction information will be described.

### Example 1

The reaction information may include input information showing an evaluation of the driving of the driver of the vehicle 20 shared by the user. The input information may be information input by the user from the terminal device 10 during or after the ride-sharing. In a case where the controller 33 receives the input information showing the evaluation of the driving of the driver during the ride-sharing period, the controller 33 may consider that the input information is information input while the user is sharing a ride. Further, in a case where the controller 33 receives the input information showing the evaluation of the driving of the driver immediately after the position of the vehicle 20 and the alighting position of the reservation information do not match, the controller 33 may consider that the input information is information input after the user shares a ride.

The controller 33 may estimate the preference degree by analyzing the evaluation of the driving of the driver of the vehicle 20. In a case where the preference degree is a score, the estimation of the preference degree may be a score decision. For example, in a case where the preference degree is a score, the controller 33 decides a higher score when the driving of the driver of the vehicle 20 is rated high in the evaluation than when the driving of the driver of the vehicle 20 is rated low in the evaluation.

The controller 33 may assign the estimated preference degree to the decided classification of the driving habit of the driver. The controller 33 may generate or update at least some of the preference information with the classification of the driving habit of the driver to which the preference degree is newly assigned. In a case where the classification of the driving habit of the driver to which the preference degree is newly assigned does not exist in the preference information, the controller 33 may generate some of the preference information by including the classification of the driving habit to which the preference degree is newly assigned in the preference information. In a case where the classification of the driving habit of the driver to which the preference degree is newly assigned already exists in the preference information, the controller 33 may replace the preference degree assigned to the classification of the driving habit that already exists with a new preference degree, in the preference information. The controller 33 may update at least some of the preference information by replacing the preference degrees of the classifications, in the preference information.

### Example 2

The reaction information may include the biometric information of the user. The controller 33 may receive the biometric information of the user from the vehicle 20 via the network 40, by the communication unit 31. The controller 33 may transmit the notification showing the transmission request of the biometric information of the user to the vehicle 20 that the user is sharing via the network 40, by the communication unit 31. During the ride-sharing period, the controller 33 may transmit the notification showing the transmission request of the biometric information of the user to the vehicle 20 that the user sharing at preset time intervals. The time interval may be appropriately set based on a time interval at which the biometric information of the user may change. As described above, the biometric information of the user may be at least any of the pulse rate, blood pressure, and the respiratory rate.

The controller 33 may estimate the preference degree of the user for the driving habit of the driver of the vehicle 20 shared by the user from the biometric information of the user as the reaction information. In a case where the preference degree is a score, the estimation of the preference degree may be the score decision. For example, in a case where the preference degree is a score, the controller 33 analyzes the biometric information of the user and decides a higher score when the user is estimated to be relaxed than when the user is estimated to be stressed.

The controller 33 assigns the estimated preference degree to the decided classification of the driving habit of the driver. In the same manner as in Example 1, the controller 33 may generate or update at least some of the preference information with the classification of the driving habit of the driver to which the preference degree is newly assigned.

### Example 3

The reaction information may include the face image of the user. The controller 33 may receive the face image of the user from the vehicle 20 via the network 40, by the communication unit 31. The controller 33 may transmit the notification showing the transmission request of the face image of the user to the vehicle 20 that the user is sharing via the network 40, by the communication unit 31. During the ride-sharing period, the controller 33 may transmit the notification showing the transmission request of the face image of the user to the vehicle 20 that the user sharing at preset time intervals. The time interval may be appropriately set based on a time interval at which the face image of the user may change.

The controller 33 may estimate the preference degree of the user for the driving habit of the driver of the vehicle 20 shared by the user from the face image of the user as the reaction information. In a case where the preference degree is a score, the estimation of the preference degree may be the score decision. For example, in a case where the preference degree is a score, the controller 33 analyzes the face image of the user and decides a higher score when the user is estimated not to get car sickness than when the user is estimated to get car sickness.

The controller 33 assigns the estimated preference degree to the decided classification of the driving habit of the driver. In the same manner as in Example 1, the controller 33 may generate or update at least some of the preference information with the classification of the driving habit of the driver to which the preference degree is newly assigned.

Operation of Information Processing System

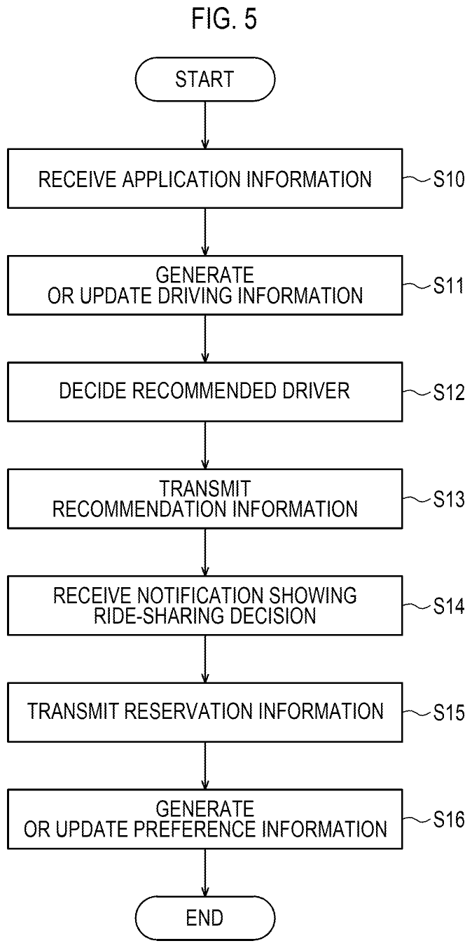

An example of an operation of the information processing system 1 shown in FIG. 1 will be described with reference to FIG. 5. The operation corresponds to an example of the information processing method according to the present embodiment.

The controller 33 receives the application information from the terminal device 10 via the network 40, by the communication unit 31 (step S10). The controller 33 generates or updates at least some of the driving information (step S11). The controller 33 decides the driver to be recommended to the user who applied for the ride-sharing by collating the preference information with the driving information (step S12). The controller 33 transmits the recommendation information to the terminal device 10 via the network 40, by the communication unit 31 (step S13). The controller 33 receives the notification showing the ride-sharing decision from the terminal device 10 via the network 40, by the communication unit 31 (step S14). The controller 33 transmits the reservation information to the terminal device 10 via the network 40, by the communication unit 31 (step S15). After that, the user may get on the vehicle 20. The controller 33 generates or updates at least some of the preference information (step S16).

As described above, in the information processing system 1 according to the first embodiment, the information processing device 30 decides the driver to be recommended to the user who applied for the ride-sharing from the drivers based on the driving information and the preference information. With such a configuration, the information processing device 30 can recommend the driver having the driving habit that suits the user's preference to the user who applied for the ride-sharing. Therefore, according to the present embodiment, the convenience of the user can be improved.

In addition, since the information processing device 30 can recommend the driver having the driving habit that suits the user's preference, the use of the ride-sharing service can be promoted.

### Second Embodiment

In the second embodiment, for example, in a case where a plurality of the drivers is selected, the controller 33 acquires the preference information by a machine-learned model. The model is machine-learned to output the preference information when the information for identifying the user and the driving information are input. The preference information output from the model shows the preference degree of the user who applied for the ride-sharing for the driving habit of each of the drivers.

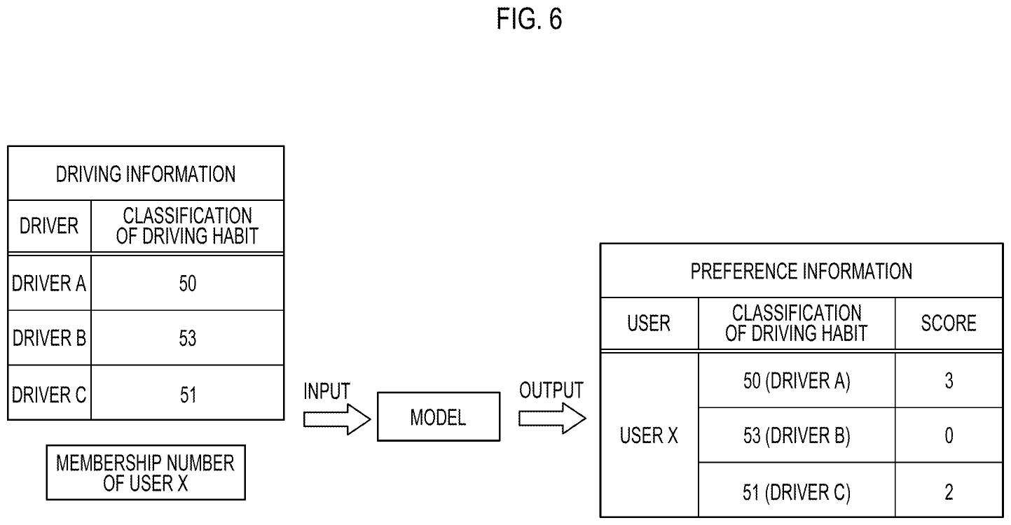

FIG. 6 shows a diagram illustrating a concept of the model according to the second embodiment of the present disclosure. In FIG. 6, the controller 33 specifies the user X as the user who applied for the ride-sharing. In this case, the controller 33 inputs a membership number of the user X as the information for identifying the user X and the driving information into the model. In FIG. 6, the driving information is the same as the driving information as shown in FIG. 4. When the membership number of the user X and the driving information are input, the model outputs the preference information showing the preference degree of the user X for the driving habit of each of the drivers A to C. That is, the model outputs the preference information showing the preference degree of the user X for the classifications 50, 51, 53.

The controller 33 decides the driver to be recommended to the user who applied for the ride-sharing from the drivers based on the acquired preference information. In a case where the driving habits are distinguished by the preset classifications, the controller 33 may specify the classification of the driving habit corresponding to the highest preference degree of the user who applied for the ride-sharing based on the acquired preference information. The controller 33 may decide to recommend the driver who belongs to the specified classification of the driving habit corresponding to the highest preference degree from the drivers. In the preference information output by the model as shown in FIG. 6, it is assumed that the preference degree for the classification 50 is the highest. In this case, the controller 33 decides to recommend the driver A who belongs to the classification 50 to the user X.

The model may assign a score to the driving habit of each of the drivers as an output of the preference information. In a case where the driving habits are distinguished by the preset classifications, the model may assign a score to the classification of the driving habit of each of the drivers, as shown in FIG. 6. The classification of the driving habit assigned a high score suits the user's preference more than the classification of the driving habit assigned a low score. The controller 33 may preferentially decide a driver having the driving habit assigned a high score from the drivers as the driver to be recommended to the user who applied for the ride-sharing. For example, the controller 33 preferentially decides the driver A having the driving habit assigned a score of “3” as shown in FIG. 6 as the driver to be recommended to the user X.

As in the first embodiment, the controller 33 may receive the driving operation information acquired in the vehicle 20 while at least one of the drivers is driving, from the vehicle 20 via the network 40, by the communication unit 31. The controller 33 may generate or update at least some of the driving information with the received driving operation information. Further, as in the first embodiment, when the controller 33 receives the above-described application information by the communication unit 31, the controller 33 may receive the driving operation information from the vehicles 20 via the network 40, by the communication unit 31. That is, as in the first embodiment, when the controller 33 receives the above-described application information by the communication unit 31, the controller 33 may generate or update at least some of the driving information. In the second embodiment, the controller 33 may input the updated driving information into the model when deciding the recommended driver.

The controller 33 may train the model using the driving information, the reaction information, and the score labeled on the reaction information as learning data. Such learning data may be supervised learning data. The reaction information may be as described above in the first embodiment. As described above in the first embodiment, the controller 33 may receive the reaction information from the vehicle 20 via the network 40, by the communication unit 31. Labeling may be executed as appropriate, depending on the type of the reaction information. For example, in a case where the biometric information of the user is used as the reaction information, the biometric information showing that the user is relaxed may be labeled with a higher score than the biometric information showing that the user is stressed. Each time the controller 33 receives the reaction information, the controller 33 may label the reaction information with a score and store the reaction information labeled with a score in the storage unit 32. When an amount of the learning data stored in the storage unit 32 reaches a preset amount, the controller 33 may train the model with the learning data. The preset amount may be appropriately set according to the machine learning algorithm adopted in the model.

Operation of Information Processing System

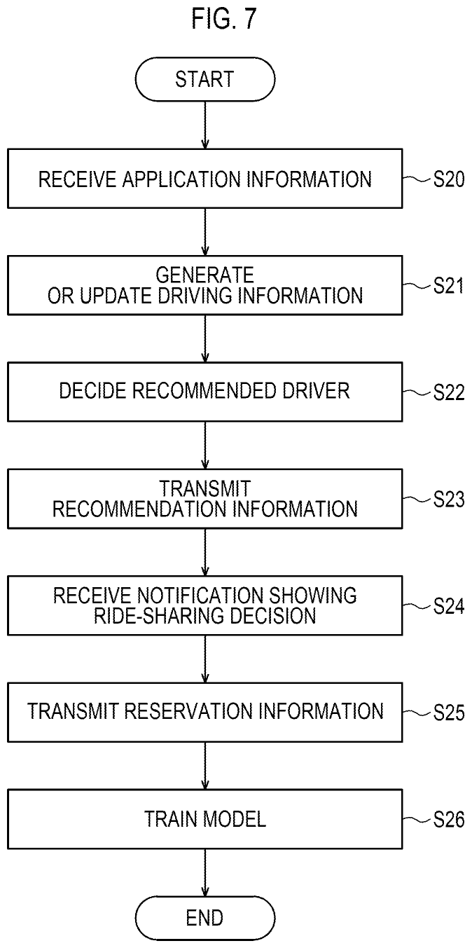

An example of an operation of the information processing system 1 according to the second embodiment will be described with reference to FIG. 7. The operation corresponds to the example of the information processing method according to the present embodiment.

The controller 33 executes the processing of steps S20, S21 in the same manner as the processing of steps S10, S11 as shown in FIG. 5. The controller 33 decides the recommended driver based on the machine-learned model (step S22). The controller 33 executes the processing of steps S23, S24, S25 in the same manner as the processing of steps S13, S14, S15 as shown in FIG. 5. After that, the user may get on the vehicle 20. The controller 33 trains the model using the driving information, the reaction information, and the score labeled on the reaction information as learning data (step S26).

Other configurations and effects of the information processing system 1 according to the second embodiment are the same as those of the information processing system 1 according to the first embodiment.

The present disclosure is not limited to the embodiments described above. For example, a plurality of blocks described in the block diagram may be integrated, or one block may be divided. Instead of being executed a plurality of steps described in the flowchart in chronological order according to the description, the steps may be executed in parallel or in a different order, as necessary, depending on the processing capacity of the device that executes each step. Other modifications are possible without departing from the spirit of the present disclosure.

What is claimed is:

1. An information processing device comprising:
a communication unit; and
a controller configured to
specify a user who applied for ride-sharing based on application information for applying for the ride-sharing received by the communication unit, and
decide a driver to be recommended to the user from a plurality of drivers, based on preference information showing a preference degree of the user for a driving habit and driving information showing a driving habit of each of the drivers.

2. The information processing device according to claim 1, wherein the controller decides the driver to be recommended to the user from the drivers by collating the preference information with the driving information.

3. The information processing device according to claim 2, wherein the controller
updates the driving information when the communication unit receives, from a vehicle, driving operation information acquired in the vehicle while at least one of the drivers is driving, and
decides the driver to be recommended to the user from the drivers by collating the preference information with updated driving information.

4. The information processing device according to claim 3, wherein the controller receives, from the vehicle, the driving operation information acquired in the vehicle while the at least one driver is driving, by the communication unit, when the communication unit receives the application information.

5. The information processing device according to claim 3, wherein the driving operation information acquired in the vehicle while the at least one driver is driving includes at least any of speed information of the vehicle, acceleration information of the vehicle, and wheel steer angle information of the vehicle.

6. The information processing device according to claim 2, wherein:
the preference degree is a score; and
a driving habit corresponding to a high score suits a user's preference more than a driving habit corresponding to a low score.

7. The information processing device according to claim 3, wherein the controller acquires the driving habit of each of the drivers in the driving information by analyzing the driving operation information.

8. The information processing device according to claim 2, wherein the controller generates or updates at least some of the preference information with driving operation information acquired in a vehicle shared by the user and a result of estimating a preference degree of the user for a driving habit of a driver of the vehicle shared by the user from reaction information showing a reaction to a driving of the driver of the vehicle shared by the user that is shown by the user during or after the ride-sharing.

9. The information processing device according to claim 8, wherein the reaction information includes input information showing an evaluation of the driving of the driver of the vehicle shared by the user that is input by the user during or after the ride-sharing.

10. The information processing device according to claim 8, wherein the reaction information includes biometric information of the user.

11. The information processing device according to claim 8, wherein the reaction information includes a face image of the user.

12. The information processing device according to claim 10, wherein the controller receives, from the vehicle shared by the user, the driving operation information acquired in the vehicle shared by the user and the reaction information, by the communication unit, and estimates the preference degree of the user for the driving habit of the driver of the vehicle shared by the user from the reaction information.

13. The information processing device according to claim 1, wherein:
the controller acquires the preference information by a machine-learned model that outputs the preference information with input of information for identifying the user and the driving information; and
the preference information output from the machine-learned model shows the preference degree of the user for the driving habit of each of the drivers.

14. The information processing device according to claim 13, wherein the controller
updates the driving information when the communication unit receives, from a vehicle, driving operation information acquired in the vehicle while at least one of the drivers is driving, and
inputs updated driving information to the machine-learned model.

15. The information processing device according to claim 14, wherein the controller receives, from the vehicle, the driving operation information acquired in the vehicle while the at least one driver is driving, by the communication unit, when the communication unit receives the application information.

16. The information processing device according to claim 13, wherein:
the machine-learned model assigns a score to the driving habit of each of the drivers as an output of the preference information, and a driving habit assigned a high score suits a user's preference more than a driving habit assigned a low score; and
the controller preferentially decides a driver having the driving habit assigned a high score from the drivers as the driver to be recommended to the user.

17. The information processing device according to claim 13, wherein the controller trains the machine-learned model using the driving information, reaction information showing a reaction to a driving of a driver of a vehicle shared by the user, and a score labeled on the reaction information as learning data.

18. The information processing device according to claim 1, wherein the drivers are drivers registered in advance in a ride-sharing service.

19. A program that causes a computer to execute an operation comprising:
receiving application information for applying for ride-sharing;
specifying a user who applied for the ride-sharing based on the application information; and
deciding a driver to be recommended to the user from a plurality of drivers, based on preference information showing a preference degree of the user for a driving habit and driving information showing a driving habit of each of the drivers.

20. An information processing method comprising:
by an information processing device, receiving application information for applying for ride-sharing;
by the information processing device, specifying a user who applied for the ride-sharing based on the application information; and
by the information processing device, deciding a driver to be recommended to the user from a plurality of drivers, based on preference information showing a preference degree of the user for a driving habit and driving information showing a driving habit of each of the drivers.
